(19) United States
(12) Patent Application Publication
(10) Pub. No.: US 2009/0080503 A1
(43) Pub. Date: Mar. 26, 2009

(54) APPARATUS AND METHOD FOR CONTROLLING AN OPERATION OF AN APPARATUS

(75) Inventors: Dietmar WENZEL, Muenchen (DE); Michael Meixner, Munchen (DE)

Correspondence Address: INFINEON TECHNOLOGIES AG;Patent Department, MUC 11.1.507, P.O. Box 221644, Munich, 80506, DE

(73) Assignee: INFINEON TECHNOLOGIES AG, Muenchen (DE)

(21) Appl. No.: 11/861,285

(22) Filed: Sep. 26, 2007

(51) Int. Cl. H04B 1/40; H04B 1/04; H04L 27/00; H04B 1/06

(52) U.S. Cl. 375/219; 375/295; 455/127.5; 455/343.5

(57) ABSTRACT

The present invention relates to various embodiments of an apparatus, particular to an apparatus comprising a radio signal transmitter and/or receiver circuitry and to a method for controlling an operation of an apparatus.

The present invention relates to an apparatus, particular to an apparatus comprising a radio signal transmitter and/or receiver circuitry and to a method for controlling an operation of an apparatus.

### BACKGROUND

A radio signal transmitter and/or receiver circuitry is used to transmit and/or receive a transmission signal via a wireless or wireline transmission channel. It performs a radio frequency (RF) signal processing. To that purpose, a radio signal transmitter modulates a useful data signal comprising an information on a radio carrier signal before feeding the resulting transmission signal into the transmission channel. The radio signal transmitter may also or alternatively perform an amplification of the transmission signal. A radio signal receiver receives the transmission signal and performs a demodulation so to extract the useful data signal. In order to perfom the signal transmission, a large number of different communication standards have been defined, such as CDMA, GSM/EDGE, UMTS, UMTS LTE, WLAN, DSL, etc. To perfom communication within a particular standard, terminal devices are provided comprising a transmitter and/or receiver circuitry. Usually, the terminal device comprises one or a plurality of semiconductor devices in which the circuitry is structured.

In a mobile communication system, a terminal device may be supplied by a battery or an accumulator. In consequence, the terminal device has a restricted power resource. As soon as the power resource is near to be exhausted, a voltage supplied to the different components of the terminal device will drop below a certain threshold. Without any countermeasure taken, this will usually lead to a situation where the terminal device has to be shut down completely.

For these and other reasons, there is a need for the present invention.

### SUMMARY

In one embodiment of the invention, an apparatus comprises an interface for receiving useful data. It further comprises an RF signal processing unit for RF signal processing at least a derivate of the useful data. The apparatus has a contact for receiving a supply voltage. A voltage detector is connected to the contact. A control unit is connected to the voltage detector and connected to the RF signal processing unit. The control unit suspends an RF signal processing of the RF signal processing unit in dependence of a voltage detection signal produced by the voltage detector.

### BRIEF DESCRIPTION OF THE DRAWINGS

The accompanying drawings are included to provide a further understanding of the invention and are incorporated in and constitute a part of this specification. The drawings illustrate embodiments of the invention and together with the description serve to explain the principles of the invention. Other embodiments of the invention and many of the intended advantages of the invention will be readily appreciated as they become better understood by reference to the following detailed description. Like reference numerals designate corresponding similar parts.

FIG. 1 illustrates an apparatus according to an embodiment of the present invention;

FIG. 2 illustrates a transmitter embodiment according to the present invention;

FIG. 3 illustrates an RF signal processing unit that may be arranged in an embodiment of the present invention;

FIG. 4 illustrates a voltage detector that may be arranged in an embodiment of the present invention; and

FIG. 5 illustrates one embodiment of a method for controlling an operation of a device according to the present invention.

### DETAILED DESCRIPTION

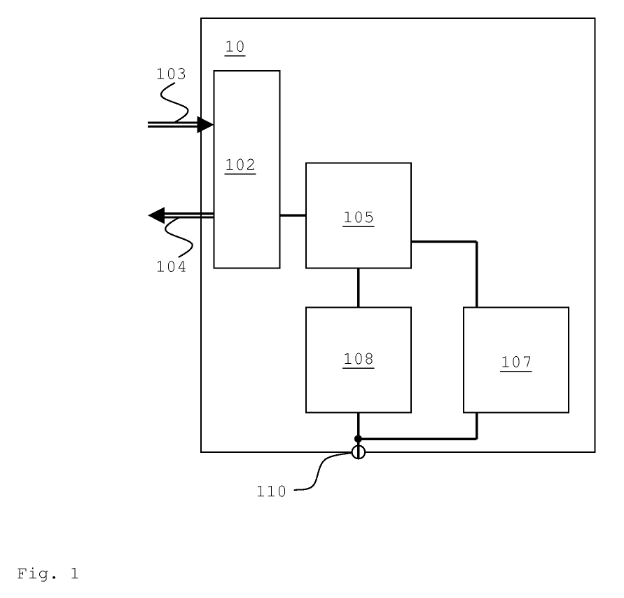

FIG. 1 illustrates an apparatus according to an embodiment of the present invention. The apparatus 10 includes an interface unit 102. The interface unit 102 may connect to a baseband component not shown in FIG. 1 by a first data line 103 and a second data line 104 to receive at least useful data. It may be disposed to negotiate a data transfer based on a digital data protocol such as defined by the DigRF™ standard. Yet the interface unit 102 may be set up for any other interface standard, including analog signal transmission standards.

The interface unit 102 connects to a control unit 105. The control unit 105 connects to an RF signal processing unit 107 and to a voltage detector 108. The RF signal processing unit 107 receives at least a part of the useful data, that part comprising at least an information to be transmitted. The RF signal processing unit 107 generates a transmission signal, e.g. by modulating the information on a carrier signal and/or by amplifying a transmission signal to a required power level. Different steps of RF signal processing may be performed, such as mixing, amplification, filtering, etc.

The apparatus 10 includes a supply voltage contact 110 connectable to an external power resource, such as a battery or an accumulator. The supply voltage terminal 110 connects to the RF signal processing unit 107 to supply loads arranged in a circuitry of the RF signal processing unit 107 with needed power. In various embodiments the battery voltage is directly supplied to the circuitry or parts of the circuitry. This circuitry may be e.g. a power amplifier, a mixer, pre-amplifying stages, such as a programmable gain amplifier, etc. In various embodiments the battery voltage is directly supplied to the circuitry or parts of the circuitry, e.g. in case of a power amplifier. In other embodiments a supply voltage of at least parts of the circuitry is derived from the battery voltage, e.g. by means of a voltage regulator, such as an LDO (low dropout) regulator, a switching regulator etc. The supply voltage contact 110 further connects to the voltage detector 108.

In operation the control unit 105 and the voltage detector 108 are activated. The voltage detector 108 senses a voltage supplied by the power ressource and delivers a measurement signal representing a measured supply voltage level to the control unit 105. In the control unit 105 a comparison of the measured supply voltage level to a threshold level is performed. The comparison may be achieved by a comparator circuitry arranged in the control unit 105. It may as well be performed by a digital signal processor or a microcontroller arranged in the control unit 105. If—during a defined period of time—the measured supply voltage level is less than the threshold level, the control unit 105 controls an output power of the transmission signal produced by the RF signal processing unit 107. This may effect an operation of a device arranged in the RF signal processing unit 107, such as a power amplifier or a mixer.

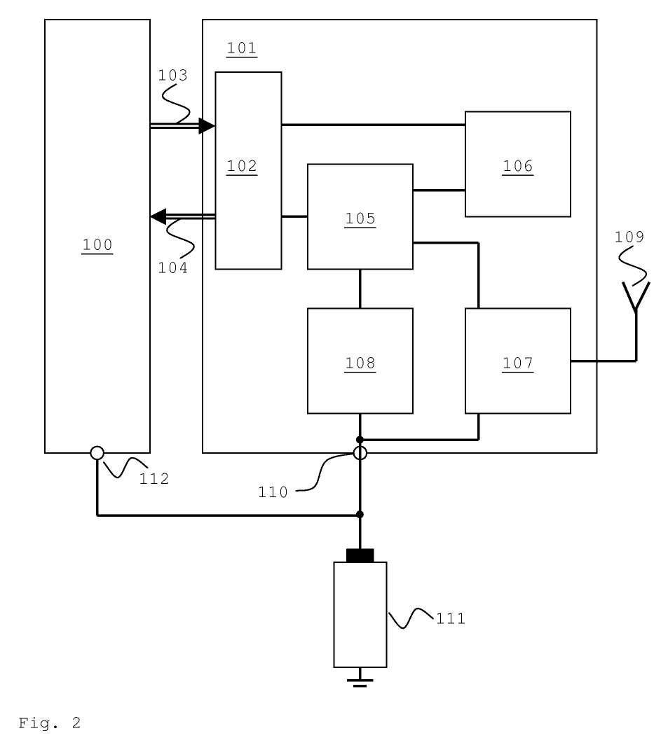

FIG. 2 illustrates a transmitter embodiment according to the present invention. The transmitter comprises a baseband component 100. The baseband component 100 connects to a transmission component 101. The transmission component 101 includes an interface unit 102. The interface unit 102 connects to the baseband component 100 by a first data line 103 and a second data line 104. It may be disposed to negotiate a data transfer based on a digital data protocol such as defined by the DigRF™ standard. Yet, the interface unit 102 may be set up for any other interface standard, including analog signal transmission standards.

In the shown embodiment, the first data line 103 is used for a transfer of useful data provided by the baseband component 100 to the transmission component 101. The first data line 103 may be arranged for a serial or parallel data transfer. The useful data comprises an information to be transmitted by the transmission component 101. It may further include information on a transmission standard and control parameters to be used for controlling the transmission of the useful data. The parameters may include information on a transmission channel, on timing of the transmission etc.

The interface unit 102 connects to a control unit 105. It further connects to a configuration memory 106. The configuration memory 106 stores a set of control parameters that may be received by the interface unit 102 or that may be pre-defined. It connects to the control unit 105. The control unit 105 connects to an RF signal processing unit 107 and to a voltage detector 108. The RF signal processing unit 107 receives at least a part of the useful data, that part comprising at least the information to be transmitted. The RF signal processing unit 107 generates a transmission signal, e.g. by modulating the information on a carrier signal. By generating the transmission signal different steps of signal processing may be performed, such as mixing, amplification, filtering, etc. The RF signal processing unit 107 connects to an antenna 109. The transmission signal is radiated via the antenna 109 into a radio channel. Alternative to the antenna 109, any feed for feeding the transmission signal into a transmission channel may be provided. E.g. this could be a plug for connecting the transmission component 101 to a wireline transmission channel such as a copper wire or an optical fibre.

The transmission component 101 connects via a supply voltage contact 110 to a battery 111. The battery 111 provides a supply voltage that is fed into the transmission component 101 via the supply voltage contact 110. The supply voltage terminal 110 is connected to the RF signal processing unit 107 and thus the battery 111 is used as power supply to loads arranged in an RF signal processing circuitry of the RF signal processing unit 107. The supply voltage contact 110 further connects to the voltage detector 108.

The battery further connects to a second supply voltage contact 112 of the baseband component 100. The baseband component 100 operates by deriving supply voltage for different cirtuitry arranged in the baseband unit 100 by means of a voltage regulator.

In operation of the transmission component 101 the control unit 105 and the voltage detector 108 are activated. The control unit 105 reads a set of parameters stored in the configuration memory 106. The voltage detector 108 senses the voltage supplied by the battery and delivers a measurement signal representing a measured supply voltage level to the control unit 105. In the control unit 105 a comparison of the measured supply voltage level to a threshold level is performed. The comparison may be achieved by a comparator circuitry arranged in the control unit 105. It may as well be performed by a digital signal processor or a microcontroller arranged in the control unit 105. If—during a defined period of time—the measured supply voltage level is less than the threshold level the control unit 105 controls an output power of the transmission signal produced by the RF signal processing unit 107. This may effect an operation of a power amplifier, or a mixer arranged in the RF signal processing unit 107.

Triggered by the same event, the controller unit 105 generates a control information signal indicating the event. The control unit 105 provides the control information signal to the interface unit 102. Depending on the definition of the interface unit 102, the control information signal is transferred to the baseband component 100 by a telegram, a data word, or via an interrupt line. A possible definition of the interface unit 102 may be based on the DigRF™ V3.09 Interface Standard or a enhanced version of the same. Yet any other suitable definition of the interface unit 102 may be applied.

In one embodiment the critical threshold of the supply voltage may be adjustable to define different scenarios. This allows for programming the apparatus depending on different applications, communication standards, locations, etc.

In one embodiment, a configuration of the control unit 105 is provided that allows for controlling the transmitter circuitry depending on a use of a specific mobile communication standard.

In one embodiment, the device is configured to perform a control or a switching off of the transmitter during a pre-defined time period. That time period may be programmable or pre-defined as a constant. In case of a constant time period an according parameter may be stored in the memory unit 106, that may be implemented as a PROM, EEPROM, a fuse array or a other non-volatile or volatile memory.

In one embodiment, an output of the voltage detector 108 is used for further information, e.g. a power control in a UMTS transmission mode.

One possibility to save power would a a discontinuation of a reansmit operation, e.g. by suspending a transmit signal generation.

There is a great variety of parameters defining the functioning of the control unit 105. One important parameter is given by the threshold value defining a critical value of the supply voltage level. This value may differ for different kinds of power supply and it may differ for different communication standards used by the transmission apparatus. Another important parameter is given by the time period during which the output power of the RF signal processing unit 107 is limited. It may also depend on the type of power supply and on the type of communication standard used by the transmission apparatus.

In an embodiment of the transmission apparatus arranged for using different kinds of communication standards, a parameter may be provided that indicates whether the control unit 105 is activated with respect to a chosen standard or whether no limitation of the output power should be performed.

If the transmission apparatus is arranged for a communication standard that uses transmission burst, e.g. TDMA (Time Division Multiple Access) as defined in the Global System for Mobile Communication (GSM) Standard or the Enhanced Data Rate GSM Evolution (EDGE) Standard, a parameter may indicate whether a single burst should be discontinued after the occurrence of an event or if a defined number of subsequent bursts should be adjourned until the baseband unit 100 resumes a data transmission by sending an according control information to the transmission unit 101. Another parameter may indicate if the control unit 105 is active for every burst.

By switching of the supply voltage within the transmission component 101 the remaining power is saved for use in the baseband component 100. This may be advantageous as described as follows by way of example for a mobile terminal. One of the major power consuming devices in the mobile terminal is a power amplifier arranged in the RF signal processing unit 107. If the power resource is getting exhausted during operation devices with high power consumption are shut down. In consequence no transmission may occur. Even though the power resource may not allow for transmitting information other functions of the mobile terminal remain operational for being used by a user. The remaining power may be used for allowing operation of other parts of the mobile terminal, such as of the baseband component 100, including application processing, such as providing information to a user about left power, an address book, GPS, music player, etc.

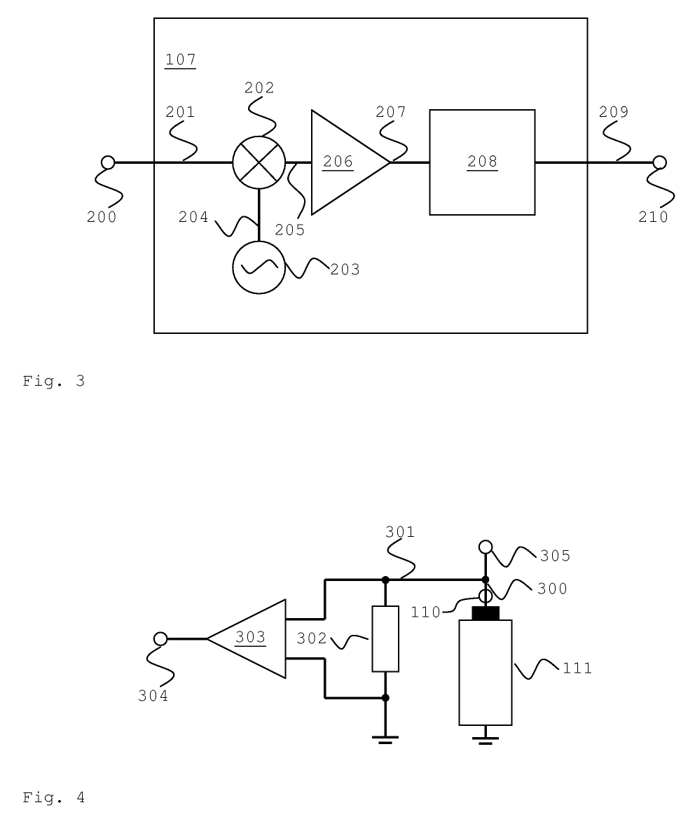

FIG. 3 illustrates an RF signal processing unit that may be arranged in a transmitter embodiment of the present invention. The RF signal processing unit 107 has an input 200 for receiving a part of the useful data, that part comprising information to be transmitted. The input 200 connects via a first line 201 to a mixer 202. The RF signal processing unit 107 comprises a frequency generator 203. The frequency generator 203 may be arranged as a voltage controlled oscillator, a phase locked loop, a delay locked loop or any other circuitry disposed to provide a carrier frequency signal, such as a sinusoidal wave, a bit-stream, a puls width modulated binary signal, etc. The frequency generator 203 connects via a second line 204 to the mixer 202. The mixer 202 performs a mixing of the part of the useful data with the carrier frequency signal thus modulating the useful data on the carrier frequency signal to produce a first modulated signal.

The mixer 202 connects via a third line 205 to an amplifier unit 206. The amplifier unit 206 may be a switched or analogue amplifier having a single or multiple amplifier stages. A gain of the amplifier unit 206 determines the transmission power of the transmission signal. The amplifier unit 206 amplifies the first modulated signal by a factor defined by the gain to produce a second modulated signal.

The amplifier unit 206 connects via a fourth line 207 to a filter 208. The filter 208 may be any filter suitable to attenuate spectral noise, such as a low-pass, high-pass or band-pass filter. The filter 208 receives the second modulated signal to produce a transmission signal. The filter 208 connects via a fifth line 209 to an output 210. The transmission signal is provided at the output 210 for further processing.

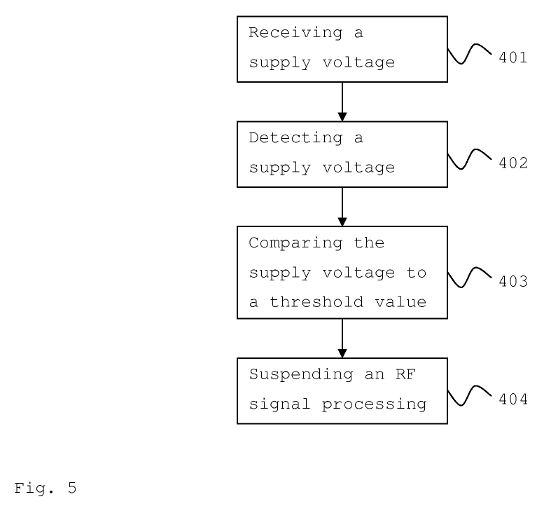

FIG. 4 illustrates a voltage detector that may be arranged in an embodiment of the present invention. The voltage detector includes a knot 300. The knot 300 connects to a supply voltage output 305. It further is connectable to a battery 111 as shown in the drawing. The knot 300 may connect to the battery 111 by a contact point 110, e.g. as shown in FIG. 1 or FIG. 2. The knot 300 connects via a line 301 to a resistor 302. The resistor 302 connects to a ground terminal. In parallel to the resistor 302 a differential amplifier 303 is arranged. The differential amplifier 303 senses a voltage at the resistor 302 and generates a detection signal that is provided at an output 304. The detection signal corresponds to a supply voltage detection signal, since its value depends on an electrical charge stored in the battery 111.

FIG. 5 illustrates one embodiment of a method for controlling an operation of an apparatus according to the present invention. The method for controlling an operation of an apparatus having a contact for receiving a supply voltage and an RF signal processing unit for RF signal processing at least a derivate of the useful data comprises a first step 401 in which the supply voltage is received at the contact. In second step 402 a supply voltage value is detected. In a third step 403 the supply voltage value is compared to a threshold value to produce a voltage detection signal. In a fourth step 404 an RF signal processing of the RF signal processing unit is suspended in dependence of the voltage detection signal.

The threshold value may be fixed or can be set according to various criteria. Therefore the threshold value may be retrieved from a plurality of distinct threshold values.

In one embodiment, a control information is generated if the signal processing of the RF signal processing unit is suspended; and the control information is provided at an output of the device. The control information may be provided as digital telegram or as interrupt signal.

In one embodiment, the signal processing of the RF signal processing unit is suspended during a defined time interval. The signal processing may be resumed after the defined time interval.

In one embodiment, the signal processing of the RF signal processing unit may be resumed if a target transmit power is lower than a transmit power threshold value.

Although the invention has been shown and described with respect to certain embodiments, equivalent alterations and modifications will occur to others skilled in the art upon the reading and understanding of this specification and the annexed drawings. For example, although bipolar or CMOS technologies are used in various embodiments of the invention, in other embodiments, other suitable technologies can be used. In regard to the various functions performed by the above described components or circuits, terms used to describe such components are intended to correspond, unless otherwise indicated, to any component which performs the specified function of the described component (i.e., that is functionally equivalent), even though not structurally equivalent to the disclosed structure which performs the function in the exemplary embodiments of the invention. Terms such as “connected” should be interpreted to mean either directly connected or indirectly connected. Terms such as “coupled” should be interpreted to mean either directly coupled or coupled connected. Furthermore, to the extent that the term “includes” is used in either the detailed description or the claims, such term is intended to be inclusive in a manner similar to the term “comprising.” While a particular feature of the invention may have been disclosed with respect to only one of several embodiments of the invention, such a feature may be combined with one or more other features of the other embodiments as may be desired and advantageous for any given or particular application.

What is claimed is:

1. An apparatus comprising:
an interface for receiving useful data;
an RF signal processing unit for RF signal processing at least a derivate of the useful data;
a contact for receiving a supply voltage;
a voltage detector connected to the contact; and
a control unit connected to the voltage detector and connected to the RF signal processing unit;
whereby the control unit suspends an RF signal processing of the RF signal processing unit in dependence of a voltage detection signal produced by the voltage detector.

2. An apparatus of claim 1, whereby the interface comprises a terminal to provide a first signal indicating a suppression state of the signal processing.

3. An apparatus of claim 1, comprising a memory connected to the control unit.

4. An apparatus of claim 1, comprising a digital interface.

5. An apparatus of claim 4, the digital interface being arranged to receive and/or transmit a digital word indicating a suppression state of the signal processing.

6. An apparatus of claim 1, the control unit comprising a comparator that compares the voltage detection signal to a threshold value.

7. A transmitter comprising:
a power supply terminal;
a power control unit connected to the power supply terminal;
an RF signal processing unit for generating a transmission signal connected to the power control unit;
the power control unit and the RF signal processing unit being structured in one integrated apparatus; and
the power control unit being disposed to activate or deactivate the RF signal processing unit.

8. A transmitter according to claim 7, comprising:
a demodulation unit for demodulating a reception signal.

9. A transmitter according to claim 7, comprising:
a digital interface connectable to a baseband unit.

10. A transmitter according to claim 9, wherein the digital interface is arranged for a telegram communication.

11. A transmitter according to claim 7, comprising:
an analogue interface connectable to a baseband unit.

12. A method for controlling an operation of an apparatus having a contact for receiving a supply voltage and an RF signal processing unit for RF signal processing at least a derivate of the useful data, comprising:
receiving the supply voltage at the contact;
detecting a supply voltage value;
comparing the supply voltage value to a threshold value to produce a voltage detection signal; and
suspending an RF signal processing of the RF signal processing unit in dependence of the voltage detection signal.

13. A method according to claim 12, comprising:
setting the threshold value.

14. A method according to claim 12, comprising:
retrieving the threshold value from a plurality of distinct threshold values.

15. A method according to claim 12, comprising:
generating a control information if suspending the signal processing of the RF signal processing unit; and
providing the control information at an output of the device.

16. A method according to claim 15, comprising:
providing the control information as digital telegram.

17. A method according to claim 12, comprising:
suspending the signal processing of the RF signal processing unit during a defined time interval.

18. A method according to claim 17, comprising:
resuming the signal processing of the RF signal processing unit after the defined time interval.

19. A method according to claim 12, comprising:
resuming the signal processing of the RF signal processing unit if a target transmit power is lower than a transmit power threshold value.
